(19) United States
(12) Patent Application Publication
(10) Pub. No.: US 2007/0174139 A1
(43) Pub. Date: Jul. 26, 2007

(54) Mobile music store and performance venue

(76) Inventor: Otis Brock, Staten Island, NY (US)

Correspondence Address: Mark Sgantzos;THE MARTINEZ GROUP PLLC, Suite 1-D, 55 Poplar Street, Brooklyn Heights, NY, 11201-6930, US

(21) Appl. No.: 11/328,389

(22) Filed: Jan. 9, 2006

(51) Int. Cl. G06Q 30/00

(52) U.S. Cl. 705/27

(57) ABSTRACT

A mobile music store and performance venue wherein the music store can be placed at a location convenient to consumers of recorded music products. More specifically a vehicle which provides a mobile musical performance stage that contains a retail store for selling musical recordings on both physical recording medium and by wireless transmission, in which the vehicle can be brought to a location convenient to the customers of such products, wherein customers can purchase the above-referenced recorded music products from either a walk-up window or, in another embodiment of the present invention, wherein the customer can enter the mobile retail store and is provided with sales help, listening devices and the ability to consummate purchases within the mobile store before leaving with either a physical recorded musical product such as a CD-ROM and DVD or a digitally or wirelessly transmitted recorded musical product.

### BACKGROUND OF THE INVENTION

1. Field of the Invention

The present invention relates generally to a device for providing a combined mobile music concert venue and retail store for recorded music at a time and location convenient to consumers of recorded music products. More specifically the present invention relates to a vehicle which provides a mobile musical performance stage that contains a retail store for selling musical recordings on both physical recording medium and by wireless transmission, in which the vehicle can be brought to a location convenient to the customers of such products, wherein customers can purchase the above-referenced recorded music products from either a walk-up window or, in another embodiment of the present invention, wherein the customer can enter the mobile retail store and is provided with sales help, listening devices and the ability to consummate purchases within the mobile store before leaving with either a physical recorded musical product such as a CD-ROM and DVD or a digitally or wirelessly transmitted recorded musical product.

Additionally, the present invention further provides a mobile musical performance stage whereby musical artists whose works will be sold in the mobile retail store can perform on the top of the vehicle by means of a stage. The stage being equipped with audio visual accessories for showing and projecting enhanced sound, graphics and advertising of the featured musical artists and their corporate sponsors or other advertising before, during and after a performance so as to feature the recorded musical works that are available for sale in the attached mobile music store.

2. Related Art

Conventional recorded music retail stores have been located at fixed positions as stand-alone stores or as part of shopping centers or malls or at some other fixed physical location. Accordingly, customers travel to the stores to buy musical products such as recordings. As such, a customer may browse through the merchandise that is display and sales help may be provided for the customer so as to give advice and assist in the purchase in the recorded musical product. Further, at conventional music stores, customers can generally listen to the musical recordings before purchasing the musical works so as to ensure that the recorded musical works are appropriate for the customer's needs and musical tastes. The customer is generally made aware of the location of the store through mass media advertising.

Other methods of retailing recorded music are also known. For example, it is known that printed catalogs can be sent to the homes of potential customers such that a potential customer may browse through the catalog and contact the store or the office from which the catalog was sent to place an order so as to have the recorded musical merchandise delivered via mail or another type of delivery service. However, this type of shopping has drawbacks. For example, the merchandise is not dynamic, not interactive and does not provide an opportunity for the consumer to listen to the recorded musical works prior to purchasing the recorded music product. Catalogs may show packaging or musical works listings that do not comport with the actual goods that the customer receives after placing and paying for a recorded musical work.

Similar shopping for recorded musical works can occur over the Internet, wherein a consumer can use an electronic catalog to browse through merchandise and place and pay for recorded musical works for subsequent physical delivery by mail or other delivery service. It is also known that shopping for recorded musical works can occur over the Internet wherein a consumer uses an electronic catalog to browse through and place and pay for recorded musical works for delivery by digital transmission directly to the consumers computer for use on either or both the consumer's computer or other digital musical playback devices such as a portable MP3 music listening device.

Another alternative merchandising method includes selling recorded musical works from a vehicle. An advantage of selling recorded musical works from a vehicle is that the vehicle is mobile and can move from place to place. However, most recorded merchandise sold from a vehicle, either at flea markets or other locations, only allow the customer to view the merchandise housed within the vehicle in a poor quality retail environment and usually without the opportunity to listen to the recorded musical works prior to purchasing.

Another disadvantage is that many recorded musical works sold from vehicles are illegally made recordings that may be of poor or otherwise substandard quality. Such musical recorded works disappoint the customer and undermine the business goodwill and reputations of the musical artists whose works are contained on the recordings. Furthermore, such illicit recordings take away the profits that both the musical artist and their sponsor might have enjoyed from a legitimate sale of the recorded musical work. Accordingly, what is needed and has not heretofore been invented, is a flexible mobile merchandising method wherein a targeted customer can be contacted directly or by advertising for the purposes of attending a mobile performance of a musical group or review at a location convenient to the consumer, such that a consumer can be entertained and then later enter a mobile store, review an inventory of recorded musical works on display, receive suggestions and or advice from a salesperson therein, listen to recorded musical works of interest and purchase and receive recorded musical works, taking delivery of the same on either physical media or by digital or wireless transmission at or from the within the vehicle.

None of the previous efforts in this are, taken either alone or in combination, teach or suggest all of the benefits and the utility of the present invention.

### OBJECTS AND SUMMARY OF THE INVENTION

It is a primary object of the present invention to provide a vehicle for selling recorded music merchandise to a customer at a location and time convenient to the customer.

It is another object of the present invention to provide a method of selling recorded music merchandise to a customer which is mobile but has all of the facilities one encounters at fixed location store.

It is another object of the present invention to identify target customers and then contact such customers by direct telemarketing or by the Internet so as to provide the vehicle at suitable locations.

It is another object of the present invention to provide a vehicle for selling recorded music merchandise to customers at remote locations which includes merchandising recorded musical works to customers, providing suggestions and advice to customers, allowing customers to listen to recorded musical works, allowing customers to browse through recorded musical work inventory and allowing customers to purchase merchandise at the mobile store location.

It is another object of the present invention to provide a mobile retail store for selling recorded music merchandise to customers at remote locations which include the selling of recorded musical works on physical media, such as CD-ROM and DVD and the sale of recorded musical works by wireless transmission or by digital transmission either by direct cabled hook-up or by wireless transmission to a device owned by the customer.

It is an additional object of the present invention to provide a mobile vehicle wherein one can purchase recorded musical works in any desired manner, such as, with currency or with charge, debit or credit cards.

It is another object of the present invention to provide a mobile retail store which sells recorded music merchandise to a customer which also includes a live music performance stage for the artist to perform upon.

It is another object of the present invention to provide a vehicle having a performance stage on top of the vehicle which is provided with audio equipment and multi-media sound and visual presentations and advertising that appears both on the mobile store itself and that are further projected either by means of high intensity lamps or lasers onto surfaces that are near the location of the mobile store.

It is an additional object of the present invention to provide a vehicle modified to display recorded music merchandise.

It is an additional object of the present invention to provide a vehicle which functions as a mobile billboard.

It is an additional object of the present invention to provide a vehicle which functions as a means of projecting and displaying pre-recorded musical works in both audio and visual form.

It is an additional object of the present invention to provide a vehicle which provides a projected display of both still and moving images on buildings that are near the location of the vehicle.

The present invention achieves these objectives by means of a vehicle which sells recorded music merchandise, particularly recorded music works to customers at locations convenient to the customer and remote from nearby music stores. Initially, potential customers are identified and contacted by direct telemarketing or over the Internet by a distributor which plans to promote a live performance. If a customer is interested in purchasing such merchandise or otherwise wishes to attend a live musical performance, an appointment is scheduled at a location geographically convenient to such customers. At the appointed time and date, the mobile store and performance venue is driven to the appointed location. A customer can view the live performance and either before, during or after any such performance can enter the vehicle and browse through the inventory displayed with the vehicle. A salesperson can merchandise the inventory and provide advice and suggestions to the customer. The customer can listen to the recorded musical merchandise within the vehicle. The customer can purchase the recorded musical works within the vehicle. The vehicle is further equipped with advertising graphics, LCD or Plasma type displays for direct advertising from the vehicle. The vehicle is further equipped with high intensity lamp projectors or lasers for the projection of the live performance of the musical group then performing or of advertising.

### BRIEF DESCRIPTION OF THE DRAWINGS

FIG. 1 is a perspective view of the mobile music store and performance venue projecting advertising onto a side of a building.

FIG. 2 is a top plan view of the mobile store and performance venue where a performance platform is extended so as to provide a stage for a live performance.

FIG. 3A is a side view of the mobile store and performance venue having windows and display screens where music videos and advertising can be displayed to the prospective consumer.

FIG. 3B is the other side view of the mobile store and performance venue depicting windows where a prospective customer can purchase music.

FIG. 4 is an interior view of the mobile retail store.

FIG. 4A is an interior view of the mobile retail store depicting listening stations where a prospective customer can listen to recorded music.

### DETAILED DESCRIPTION OF THE INVENTION

The present invention relates to a vehicle for selling merchandise, particularly recorded musical merchandise, to customers that, for one reason or another, do not desire to visit fixed retail store locations that sell recorded musical works. For example, customers with little time to travel or customers whose musical tastes are not catered to by the local retail store outlets for recorded musical works.

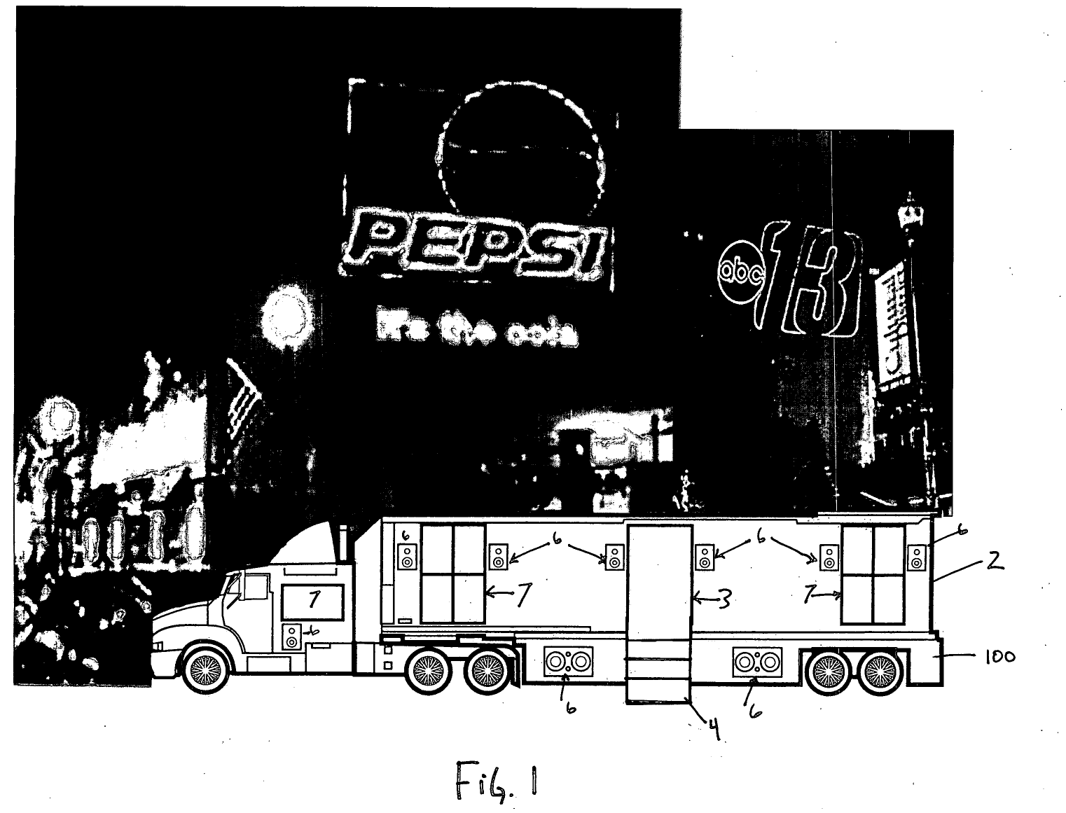

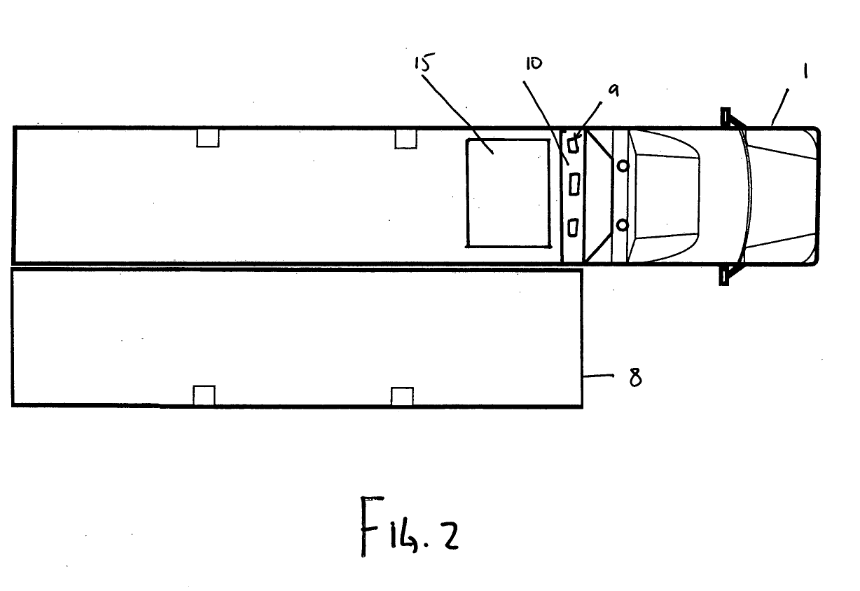

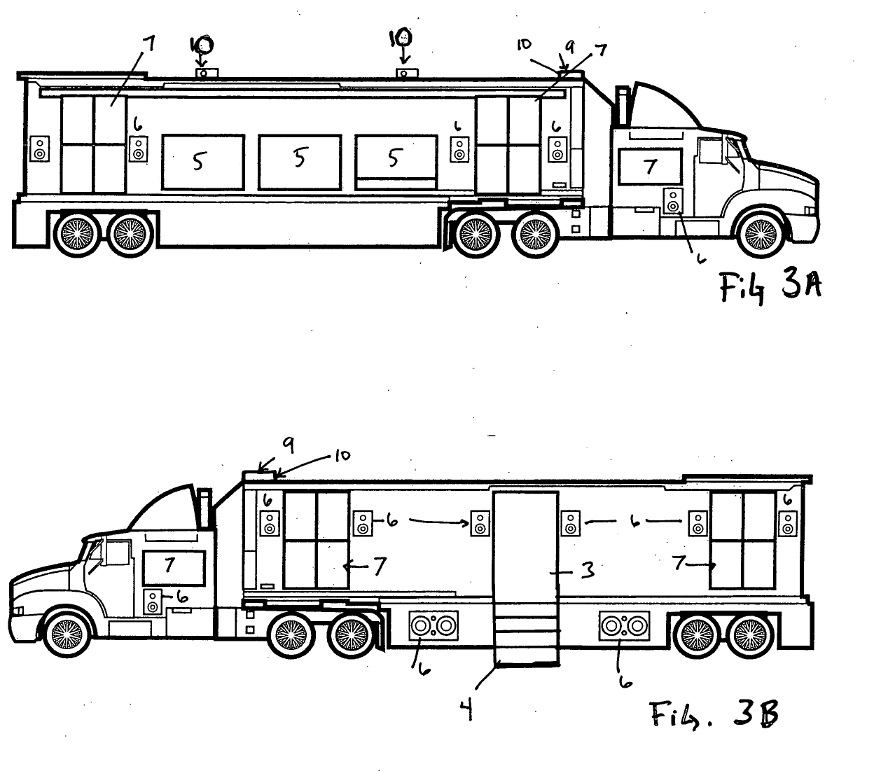

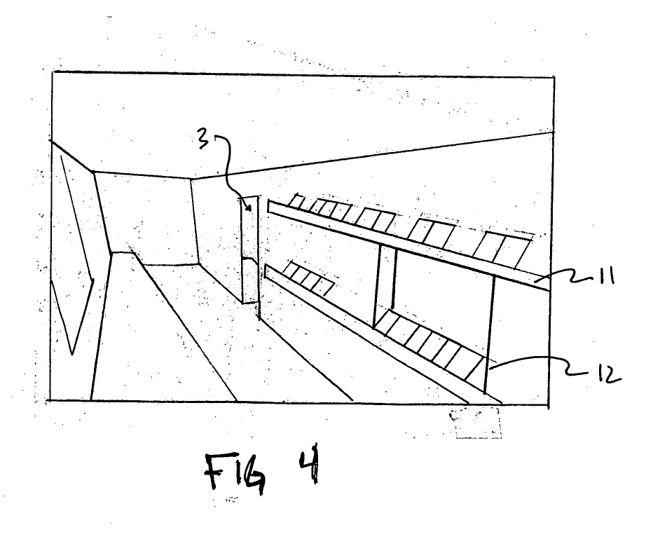

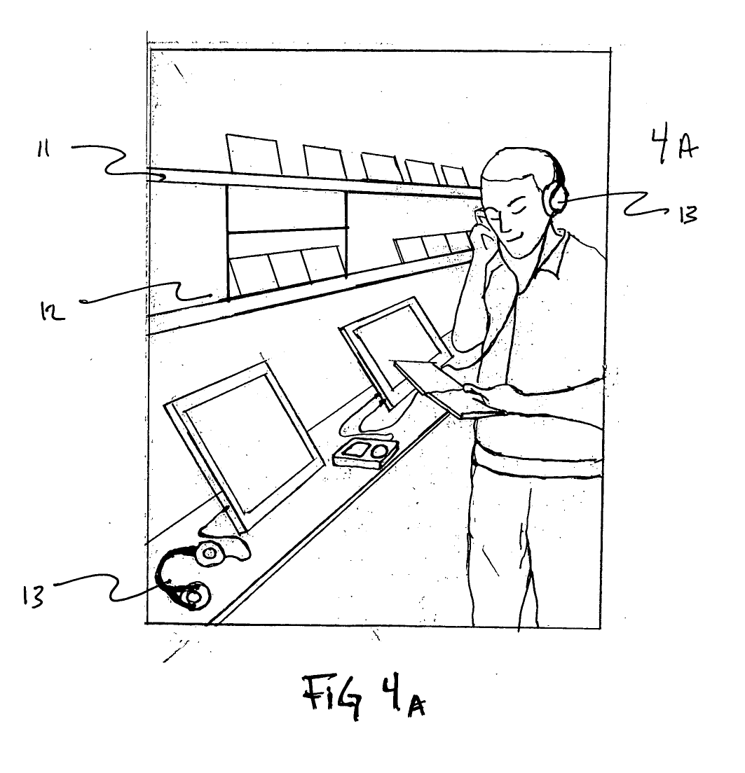

The mobile store and performance venue essentially is comprised of a vehicle as substantially shown in the figures. The vehicle 100, includes a tractor type motor portion 1 and a store/performance venue portion 2 with an access door 3. The windows 5 provide a means by which a consumer can purchase music without entering the mobile store in the event that a live performance is draws a large crowd. FIG. 1 further shows audio speakers which broadcast music so as to advertise the type of music available in the store. Display screens 7 are located between the windows 5 which broadcast available music for sale which can also include advertising new releases or information pertaining to a live event. FIG. 2 shows a top view of the mobile store where a retractable platform 8 extends from the top of the mobile store to provide a stage in which performers can perform. The top of the mobile store is provided with audio and power connections 9 so that the performing artists can connect suitable equipment thereto in order to broadcast their music. The connections 9 can also be connected to speakers 6 so that the performance can be heard throughout the area. The top of the venue portion is also provided with projectors 10 which can broadcast the live performance by means of lasers or high intensity projectors onto sides of buildings so that the performance can be viewed from a distance. The projectors 10 are also capable of projecting sponsor products or other suitable advertising when a performance is not scheduled. FIG. 2 shows an elevator lift. FIGS. 3A and 3B show side views of the mobile store further detailing the windows 5 and the display screen 7 wherein FIG. 3B shows the door having steps. FIG. 4 shows a cut away view of the venue portion 2 detailing the interior of the mobile store wherein music merchandise can be purchased. The interior of the mobile store and performance venue as shown in FIG. 4 is adapted to display prerecorded music merchandise equipped with shelves 11 as would a fixed retail store which would display the music merchandise. As shown in FIG. 4A, display racks 12 and listening devices 13 are attached to the inside perimeter of the vehicle to provide a fixed, sturdy support for the merchandise 14 where customers can listen to recorded music works available for purchase.

In use, a customer enters the mobile store and performance venue through a door 3 by ascending steps 4 into the vehicle. Standing within the vehicle a customer can view, peruse and listen to recorded musical works displayed inside the vehicle. A space is provided within the vehicle for customers to listen to recorded musical works before deciding to purchase the merchandise available in the mobile store. A payment device such as a cash register means may be provided within the vehicle along with a device to accept credit and/or debit card type payments interconnected with a wireless means to allow the payment devices to connect with the parties authorizing credit card and/or debit card payments. When a customer enters the mobile store, a sales associate can identify the type of recorded musical works the customer desires or can identify where the works of the featured musical artists are located or where such works may be listened to prior to purchasing. The customer can browse the inventory of the recorded musical works on display within the vehicle. The customer can listen to the prerecorded musical works at another location within the vehicle. The customer can take delivery of the recorded musical works in either physical media such as CD-ROM or DVD or by wireless transmission to a customer's computer or similar electronic device or arranging for the delivery of the recorded musical work over the Internet to the delivery address the customer so instructs.

After finishing with customers at one location, the mobile store and performance venue can be moved to another location whereat subsequent customers can purchase music or view the performance.

As described above, the mobile store and performance venue of the instant invention provides a number of advantages, some of which have been described above and others, which are inherent in the instant invention. Modifications may be proposed to the mobile store without departing from the teachings herein such as changing the shape and orientation of the windows and display screen to specifically suit a certain type performance. Musical works are not only limited to recorded song but can comprise and should not be construed as being limited to musical compositions, dramatic works, spoken works and other musical works for use in electronic devices such as ring tones for cellular type telephones and other hand-held devices. Sales and other information can be provided to customers by still and moving image displays and by musical speakers positioned both inside and outside of the mobile store and performance venue. The sales of the musical works can also be provided by user actuated terminals which can be self actuated by the consumer and downloaded to an electronic device of the users choosing. Accordingly, the scope of the invention is only to be limited as necessitated by the accompanying claims.

Having thus described the invention in detail, it is to be understood that the foregoing description is not intended to limit the spirit and scope thereof. What is desired to be protected by Letters Patent is set fort in the appended claims.

What is claimed is:

1. A vehicle having a motor portion and a venue portion, comprising:
a mobile retail music recording store displaying the inventory of prerecorded musical works within the vehicle for a customer to purchase; and performance venue wherein the performance venue accommodates live performances by musical artists.

2. The vehicle as defined in claim 1, wherein the customer is permitted to listen to recorded musical works within the vehicle.

3. The vehicle as defined in claim 2, wherein the customer is permitted to select the manner in which the recorded musical work is taken into possession.

4. The vehicle as defined in claim 3, wherein the recorded musical work is purchased as physical media such as a CD-ROM or DVD.

5. The vehicle as defined in claim 3, wherein the musical work is purchased by wireless transmission.

6. The vehicle as defined in claim 3, wherein the musical work is purchased by direct connection to a customer's electronic device.

7. The vehicle as defined in claim 3, wherein the musical work is purchased and transmitted by electronic transmission over the internet to an electronic mail address specified by the customer.

8. The vehicle as defined in claim 1, wherein the venue portion having at least one audio speaker and at least one visual display screen; the display screen being affixed to the outside of the vehicle.

9. The vehicle as defined in claim 8, wherein the venue portion having a door and steps to enter the interior of the venue portion to purchase the musical works.

10. The vehicle as defined in claim 9, wherein the venue portion having at least one window so as to sell musical works without entering the vehicle.

11. The vehicle as defined in claim 9, wherein the venue portion having an interior display section to view the musical works and musical listening stations.

12. The vehicle as defined in claim 1, wherein the venue portion having a top section where live performances can be performed.

13. The vehicle as defined in claim 1, wherein the venue portion having a top section further having a lift section of a well-known type, where the musical artists can be delivered to the top section by means of the raising or lowering of the lift.

14. The vehicle as defined in claim 11, wherein the top section is provided with a projector for the projection of the live performance onto a building wall and connections to provide audio and power to the musical artists.

15. The vehicle as defined in claim 12, wherein the projector projects an image of an advertising sponsor on the building wall.

16. The vehicle as defined in claim 12, wherein the projector is comprised of high intensity lamp projectors.

17. The vehicle as defined in claim 12, wherein the projector is comprised of lasers.

18. The vehicle as defined in claim 11, wherein the top section is comprised of a retractable platform.
